(19) United States
(12) Patent Application Publication
(10) Pub. No.: US 2004/0080932 A1
(43) Pub. Date: Apr. 29, 2004

(54) Door sensing illumination device

(76) Inventor: Ronald Takashi Hata, Midway, KY (US)

Correspondence Address: Ron T. Hata, 120 Cottage Garden Lane, Midway, KY, 40347, US

(21) Appl. No.: 10/280,713

(22) Filed: Oct. 25, 2002

(51) Int. Cl. F21L 4/02

(52) U.S. Cl. 362/184; 362/276

(57) ABSTRACT

This document describes a automatic lighting device that provides temporary illumination to assist an individual in locating a light switch or other source of light during low light conditions. This design incorporates improved performance, features, and functionality over previously published designs. The design shown here consists of a battery powered device housed by a plastic enclosure (1) approximately equivalent in size to a pack of cigarettes, and a permanent magnet (2). The device (1) is intended to be mounted above a doorway while the permanent magnet (2) is intended to be mounted to a door. The significant elements within the device (1) are batteries (3), one or more light emitting diodes (LED) (4), a magnetic field detecting element (5), a light detecting element (6), and a programmable microcontroller integrated circuit (MCU-IC) (7). Some of the primary design goals of this device are flexibility of placement, low maintenance, long battery life, and ease of use.

### BACKGROUND OF THE INVENTION—FIELD OF INVENTION

This invention relates to night lights, specifically to battery powered lighting devices for visual assistance in low light situations.

### BACKGROUND OF THE INVENTION—PRIOR ART AND DISADVANTAGES

When entering a dark room, one must generally find the nearest light switch or lamp fixture. The nearest light switch or lamp fixture is often located some distance from the point of entry making it necessary to walk a few steps in darkness before turning on a light.

A popular solution for walking in and into dark rooms is the ubiquitous night light (referred to as the common night light), the type which plugs into a standard wall power outlet, has a light sensing element, and uses 4 to 7.5 watt incandescent bulbs.

One of the drawbacks of the common night light is their reliance on external power. An interruption of external power renders these lights temporarily inoperative.

Another drawback of the common night light, one that is closely related to the external power issue, is the necessity to locate the common night light at a power outlet. It is often that a power outlet does not exist where one would ideally prefer to place a night light, resulting in night lights located at less than ideal locations within a room.

A third drawback of the common night light is that they are continuously lighted whenever the room light level is low enough. This light source in an otherwise dark room may not always be desirable, particularly to individuals who prefer to sleep with as little light as possible.

A fourth drawback of the common night light is the use of an incandescent bulb. These bulbs are known to have limited life expectancies. Purchasing, storing, replacing these bulbs can be a nuisance. Some night lights do use alternate illuminating devices that have very long life expectancies, such as neon gas type bulbs or electro-phosphorescent panels. U.S. Pat. No. 5,763,872 to Ness (1998) shows the use of an electro-phosphorescent device as an illuminating element. However, these types of lights tend to produce only enough light to illuminate objects within a few feet and usually do not provide sufficient light to find ones way around a room where they are the only source of illumination.

Inventors have attempted to improve upon older designs with limited success. Wall powered night lights with rechargeable batteries are available. Table lamps with built-in light sensing devices are available for situations where one wishes to place a night light type device at a location other than a wall outlet. Motion sensing means have been incorporated into night lights which addresses the drawback of a night light that is lighted continuously during low light conditions. U.S. Pat. No. 5,763,872 to Ness (1998) and U.S. Pat. No. 6,390,647 to Shaefer (2002), among other patents, show motion sensing elements in lighting devices.

The type of motion that these motion sensing devices are designed to detect is ambiguous. It is not clear if the inventors of these devices refer to motion of persons, objects, or some other entity. The common method of motion detection is performed by infrared light scattering, although ultrasonic sound scattering techniques have been employed in an analogous fashion. The ability of these motion sensing systems to properly function at proper moments is highly dependant upon the physical location of the device, and is often difficult to optimize. This can result in sensing false motion as well as missed motion sensing. U.S. Pat. No. 4,757,430 to Dubak (1988) and U.S. Pat. No. 4,872,095 to Dubak (1989) both show devices which appear to address some of the drawbacks of the common night light. However, the inventions proposed by Dubak are not designed for general purpose large area illumination, nor do they off a solution to the short life expectancy of incandescent type bulbs.

### BACKGROUND OF THE INVENTION—OBJECTS AND ADVANTAGES

The motivation for an improved light resulted from the disadvantages of currently available devices as cited in the preceding section. The objectives for an improved light were:

(a) powered by self-contained batteries

(b) have a battery life of approximately one year

(c) not required to be located at a power outlet

(d) not require external wires for power

(e) no false motion sensing and no missed motion sensing

(f) sufficient light output to see objects at a distance of up to 10 meters

(g) use illuminating elements which do not require periodic replacement

Further objectives were to provide a light that is compact, low cost, easy to install, easy to operate, reliable, safe, and has long service life and low maintenance.

### SUMMARY

In accordance with the present invention, an improved light comprises a surface mountable device having one or more illuminating elements, a light detecting element, a magnetic field detecting element, appropriate circuitry for controlling these elements, and appropriate software for controlling a programmable microcontroller integrated circuit, a component of the circuitry.

### DRAWINGS—FIGURES

FIG. 1 shows an elevated view of the Door Sensing Illumination Device.

FIG. 2 shows an elevated inside view of the Door Sensing Illumination Device.

FIG. 3 shows a schematic of the Door Sensing Illumination Device.

FIG. 4 shows a flowchart of the Door Sensing Illumination Device.

### REFERENCE NUMERALS

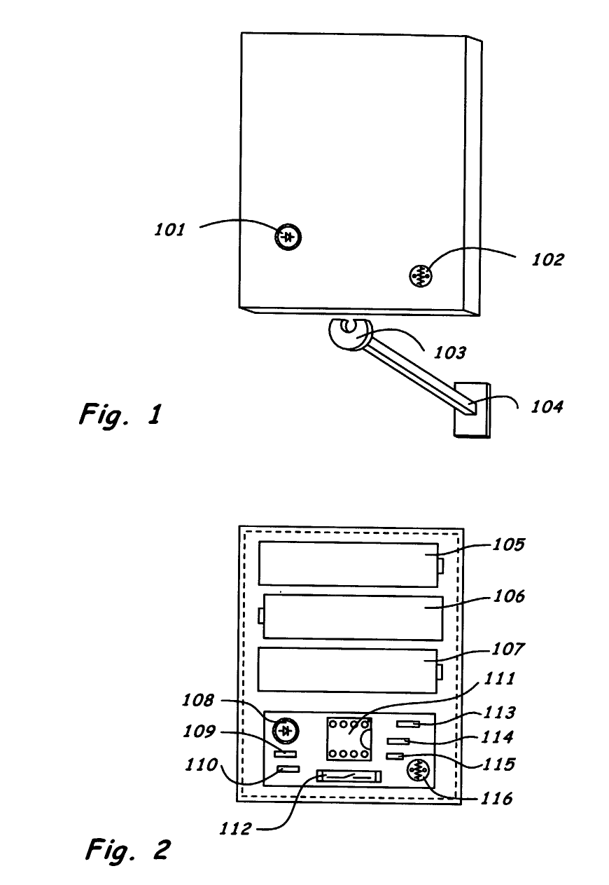

FIG. 1:

101 Aperture for a white light emitting diode (White LED)

102 Aperture for a photoresistor

103 Magnet

104 Extension arm with base

FIG. 2:

105 AA size battery

106 M size battery

107 AA size battery

108 White LED

109 Resistor

110 Resistor

111 Programmable microcontroller integrated circuit (MCU-IC)

112 Magnetic reed switch

113 Resistor

114 Resistor

115 Capacitor

116 Photoresistor

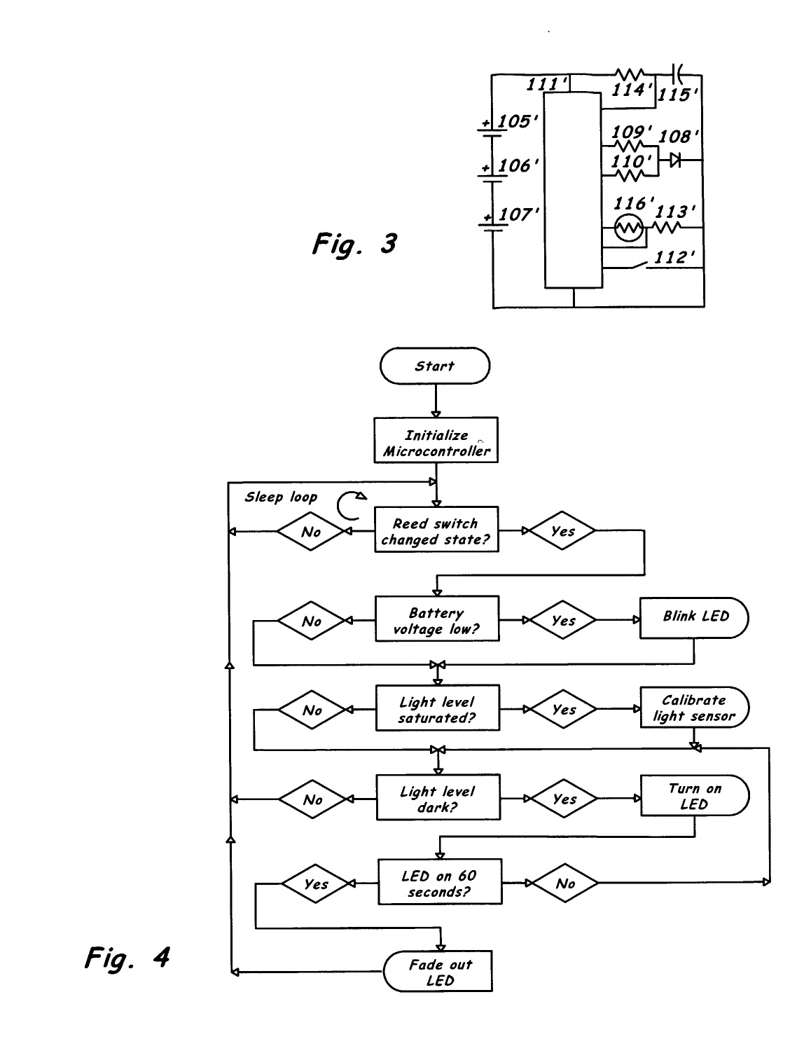

FIG. 3:

105′ Battery cell

106′ Battery cell

107′ Battery cell

108′ White LED

109′ Resistor

110′ Resistor

111′ MCU-IC

112′ Magnetic reed switch

113′ Resistor

114′ Resistor

115′ Capacitor

116′ Photoresistor

FIG. 4:

Software program flowchart

### DETAILED DESCRIPTION—FIGS. 1, 2, AND 3

A preferred embodiment of the improved light of the present invention is illustrated in FIG. 1. Aperture 101 is a circular hole in a plastic enclosure to allow light transmission from the white LED 108 of FIG. 2. Aperture 102 is a circular hole in the enclosure to allow light transmission to the photoresistor 116 of FIG. 2. Magnet 103 resides outside of the enclosure and is attached to arm 104.

An inside view of the preferred embodiment is illustrated in FIG. 2. Diode 108 is a white LED. Batteries 105, 106, and 107 are connected in series and provide the necessary supply of 4.5 volts to the MCU-IC 111. A photoresistor 116 is used to detect the amount of light in the room. A magnetic reed switch 112 is used to detect the presence of magnet 103. Resistors 114, 109, 110, 113 and capacitor 115 are necessary electronic components to support overall functioning of the circuit.

The schematic diagram for the preferred embodiment is shown in FIG. 3. Electrical component numbering in FIG. 3 corresponds to the same numbered part in FIG. 2 with the addition of a prime following the number. For example, LED 108 of FIG. 2 is the same part as LED 108′ of FIG. 3.

The MCU-IC for the preferred embodiment is an IC 16F675 programmable microcontroller manufactured by Microchip Technologies of Chandler, Ariz. A flowchart diagram of the installed software into the MCU-IC is shown in FIG. 4. Other suitable MCU-IC devices are common in the electronics industry and may be substituted for the one shown in this embodiment. The requirements for an alternate device are:

(a) the device is a programmable microcontroller integrated circuit

(b) at least 2 analog to digital converter (ADC) channels for:

1 channel for battery voltage measuring

1 channel for light level measuring

(c) voltage and current capability to directly drive LED devices, typically in the 3 volt and 20 milliamp range

(d) low idle current consumption, a typical value of less than 1 milliamp

Resistor 114′ and capacitor 115′ provide the necessary oscillator timing network for the MCU-IC 111′. The value of resistor 109′ is chosen to limit the current to the white LED 108′. The value of resistor 110′ is chosen to provide a low drive current to the white LED 108′ to exploit the non-linear current-voltage function of the white LED 108′ for the purpose of battery voltage measuring. In the normal forward bias direction at low currents, an LED device can be used as a voltage reference, similar to the reverse bias current-voltage characteristics of a zener diode. The value of resistor 113′ is chosen so that a suitable voltage drop at the node of photoresistor 116′ is developed when the photoresistor is exposed to light levels similar to the condition in which the Door Sensing Illumination Device is expected to perform.

### DETAILED DESCRIPTION—FIG. 4

The software program flowchart of FIG. 4 is a functional summary of the program code that resides within the MCU-IC. An individual skilled in the field of these types of electronic devices should find this flowchart sufficiently detailed to reconstruct an appropriate program for the MCU-IC device shown in this preferred embodiment, or any other functionally equivalent device.

Alternative Embodiments

Several alternative embodiments to the preferred embodiment cited above are discussed below.

In one alternate embodiment, a pushbutton switch is connected in parallel to the magnetic reed switch. This allows the Door Sensing Illumination Device to be activated with or without a magnet. This would allow the device to be used as a portable handheld flashlight.

In the preferred embodiment, a single magnetic reed switch is shown. In an alternate embodiment, two or more reed switches which are spatially separated, located along the path of the magnet, and contained within the same enclosure, would be utilized to provide additional information to the MCU-IC. Some of the possible forms of additional information would be the direction of the door motion, opening or closing, or the position of the door, opened or closed. This additional information would be utilized in specific MCU-IC program instructions that would allow for greater control over program execution. For example, it may be preferable to have lighting if a door is moving in the open direction, but not if the door is moving in the closing direction.

The preferred embodiment shows a single white LED device, which produces sufficient light output for user vision up to 10 meters. Incorporating two or more white LED devices in an alternate embodiment would provide better user vision at distances up to 10 meters, or allows user vision at distances greater than 10 meters. The diameters of commonly available white LED devices is 3 mm and 5 mm. The maximum electrical current capacity of these devices is typically 20 milliamps. Up to approximately 100 such devices could be incorporated into the packaging size of the preferred embodiment without significant physical enlargement. The electrical current capability of the types of batteries shown in the preferred embodiment would permit the use of up to approximately 100 white LED devices.

The use of colored LED devices in addition to the white LED device shown in the preferred embodiment is another possible alternate embodiment. The color balance of currently available white LED devices tends to be high in blue content, which causes these devices to appear bluish when compared to conventional lighting fixtures. The use of color LED devices in conjunction with white LED devices to form a close packing LED array is one method of achieving a more balanced source of white light, if so desired.

The use of mechanical or solid state relay devices connected to the MCU-IC output in place of the white LED device shown in the preferred embodiment. This alternate embodiment would allow the Door Sensing Illumination Device to control conventional line voltage lighting fixtures such as floor lamps, ceiling lights, or other high wattage lighting devices.

The use of low power, short range wireless transmitting elements in place of the white LED device shown in the preferred embodiment. This alternate embodiment would allow the Door Sensing Illumination Device to control a lighting fixture having an appropriate wireless receiving element at a short distance from the transmitting device without having to install interconnecting wires between the two devices. An example of this use is in a residential type garage with a doorway interconnecting the interior of the house. The Door Sensing Illumination Device would be located at the doorway and would activate an overhead lighting fixture upon door motion.

Operation

The Door Sensing Illumination Device shown here is designed to be mounted above a typical residential type doorway. The door may be a hinged type door or a sliding type door. In the case of a hinged type door, it may be mounted on the side that the door swings into, or may be mounted on the side that the door swings away from. A magnet (FIG. 1, 103) is attached near the top edge of the door. The magnet may be affixed directly to the door, or may be attached on the end of a short extension arm (FIG. 1, 104) to provide proper reach and clearance in certain applications.

The magnetic reed switch (FIG. 2, 112) contained within The Door Sensing Illumination Device is located near the lower inside edge of the enclosure. When a door is opened or closed, the magnet on the door moves toward or away from the magnetic reed switch, although never making direct contact with the reed switch, nor any part of the enclosure. When the magnet is in close proximity to the reed switch, the reed switch contacts are closed. Operating distances for typical reed switches is in the 1 mm to 10 mm range, depending on the choice of reed switch and the the strength of the magnet used.

The MCU-IC is always connected to the battery supply and follows a specific software program which must be loaded into the MCU-IC at some point in the manufacturing process of the Door Sensing Illumination Device. The MCU-IC spends most of its time in an idle state, also known as a sleep state. This state consumes very little current from the battery supply, in the sub-milliamp range, and thus provides extremely long battery life, typically longer than one year. The MCU-IC exits this state when it senses a change of state on the reed switch contacts. A change of state is either the electrical transition from a high state to a low state, or the electrical transition from a low state to a high state. Using appropriate programming techniques, the LED can be switched off even if the magnetic reed switch contacts remain closed, as in the case where the door is ajar and the magnet remains sufficiently close to the reed switch.

When a change of state is sensed by the MCU-IC, the MCU-IC performs a battery voltage measurement. If the battery voltage is below a specific threshold, then the LED is flashed several times to indicate that a low battery condition exists. If the battery voltage is extremely low, whereby the circuitry cannot function, no indication will be displayed.

After measuring the battery voltage and flashing the LED if necessary, the MCU-IC next performs a light level measurement. If the light level is saturated bright, as when someone aims a bright light onto the photoresistor, the MCU-IC interprets this to mean that a light level calibration has been been requested. The MCU-IC then executes a light level calibration routine. If the light level is below the saturated bright level, but above the low light threshold, the MCU-IC then sends drive current to the white LED. The white LED remains on until either a specific time has elapsed, 60 seconds for example, or until the light level exceeds the low light threshold. If the light level exceeds the low light threshold, the white LED is turned off and the MCU-IC returns to its idle state.

Advantages

From the description above, a number of advantages of the Door Sensing Illumination Device over previous designs become evident.

(a) batteries are the only source of power

(b) battery life under normal usage is approximately 1 year or greater

(c) the device can be positioned directly above a doorway

(d) no external wiring is required

(e) the light switches off after a specific length of time or when another source of light is found

(f) it does not falsely detect the motion of persons or objects

(g) it produces sufficient light for vision up to 10 meters

(h) it uses an illuminating element that does not require periodic replacement

### CONCLUSIONS, RAMIFICATIONS, AND SCOPE

The design of this invention offers significant advantages over the common night light. Low maintenance LED devices eliminate high maintenance incandescent bulbs. The high efficiency of LED devices allows batteries to be the only necessary source of electricity. Low cost MCU-IC devices allow intelligent program control of various input parameters to be implemented in this design. In the preferred embodiment, the Door Sensing Illumination Device has applications in residential homes, commercial buildings, recreational vehicles, boats, airplanes, and locations lacking wired electricity. In alternative embodiments, this device has applications for higher light output requirements, portable lighting applications, remote light triggering requirements, door position applications, and door direction applications.

I claim:

1. In an illumination device housed in a plastic enclosure comprised of electronic components.

2. Whereby the device in claim 1 wherein is intended to be affixed to a stationary location.

3. Whereby the device in claim 1 wherein is comprised of a plurality of white light emitting diodes.

4. Whereby the device in claim 1 wherein is comprised of a plurality of batteries.

5. In an illumination device housed in a plastic enclosure comprised of electronic components.

6. Whereby the device in claim 5 wherein employs means for automatically controlling emitted illumination.

7. Whereby the device in claim 5 wherein employs means for detecting a magnetic field.

8. Whereby the device in claim 5 wherein employs means for detecting the intensity of light incident to and surrounding the area external to the device.

9. In an illumination device housed in a plastic enclosure comprised of electronic components.

10. Whereby the device in claim 9 wherein employs a programmable microcontroller integrated circuit.

11. Whereby the device in claim 10 wherein employs a specific software program.

12. Whereby the device in claim 10 wherein and the device in claim 11 wherein operate in unison to control emitted illumination.
